(19) United States
(12) Patent Application Publication
(10) Pub. No.: US 2022/0379699 A1
(43) Pub. Date: Dec. 1, 2022

(54) VEHICLE COVERING ASSEMBLY

(71) Applicants: John Couture, Athens, TN (US); Shannon Couture, Athens, TN (US)

(72) Inventors: John Couture, Athens, TN (US); Shannon Couture, Athens, TN (US)

(21) Appl. No.: 17/335,950

(22) Filed: Jun. 1, 2021

(51) Int. Cl. B60J 11/04

(52) U.S. Cl. CPC B60J 11/04

(57) ABSTRACT

A vehicle covering assembly, including a plurality of vertical poles vertically disposed on a first side and a second side of a vehicle opposite with respect to the first side, a plurality of horizontal poles perpendicularly disposed away from an end of at least one of the plurality of vertical poles to suspend above a roof of the vehicle, and a plurality of vehicle connectors removably connected to at least a portion of the first side of the vehicle and the second side of the vehicle, such that each of the plurality of vehicle connectors receive at least one of the plurality of vertical poles therethrough.

### BACKGROUND

### 1. Field

The present general inventive concept relates generally to a vehicle cover, and particularly, to a vehicle covering assembly.

### 2. Description of the Related Art

Usually fixed items.

When it comes to outdoor recreational activities, people that own and/or rent a recreational vehicle (RV) frequently experience some threat from nature such as wind, rain, and/or even sunlight. In other words, various weather conditions can cause damage to a roof to the RV. Additionally, any items stored on the roof will sustain damage from the weather. The type of damage includes paint damage, water penetration, supply damage, insulation deterioration, etc. Unfortunately, repairing this damage can be costly.

Currently, some vehicle covers are available, but these tend to be fixed on the RV. As such, these vehicle covers are also prone to damage because of constant exposure to the outdoors.

Therefore, there is a need for a vehicle covering assembly that can be assembled to protect a vehicle from outdoor elements.

### SUMMARY

The present general inventive concept provides a vehicle covering assembly.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a vehicle covering assembly, including a plurality of vertical poles vertically disposed on a first side and a second side of a vehicle opposite with respect to the first side, a plurality of horizontal poles perpendicularly disposed away from an end of at least one of the plurality of vertical poles to suspend above a roof of the vehicle, and a plurality of vehicle connectors removably connected to at least a portion of the first side of the vehicle and the second side of the vehicle, such that each of the plurality of vehicle connectors receive at least one of the plurality of vertical poles therethrough.

The plurality of vertical poles may be suspended from the plurality of vehicle connectors above a ground surface while the plurality of vehicle connectors are connected to the vehicle.

Each of the plurality of vehicle connectors may include a cushion portion circumferentially disposed within at least a portion of an interior surface of each of the plurality of vehicle connectors to snugly receive at least one of the plurality of vertical poles therein.

The cushion portion may at least partially deform in response to contact from at least one of the plurality of vertical poles.

The vehicle covering assembly may further include a plurality of corner pole connectors removably connected to at least a portion of the end of at least one of the plurality of vertical poles to removably connect at least one of the plurality of vertical poles to at least one of the plurality of horizontal poles, such that each of the plurality of corner pole connectors suspends at least one of the plurality of horizontal poles on at least one of the plurality of vertical poles.

The vehicle covering assembly may further include a plurality of divider connectors removably connected to at least a portion of the end of at least one of the plurality of vertical poles and disposed between two of the plurality of corner pole connectors on at least one side of the vehicle to removably connect at least one of the plurality of vertical poles to at least one of the plurality of horizontal poles, such that each of the plurality of divider connectors suspends at least one of the plurality of horizontal poles on at least one of the plurality of vertical poles.

The vehicle covering assembly may further include a plurality of covers removably connected and suspended between each of the plurality of horizontal poles to cover at least a portion of the roof and a body of the vehicle.

The plurality of covers may prevent ultraviolet light from passing therethrough.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric view of a vehicle covering assembly, according to an exemplary embodiment of the present general inventive concept; and

FIG. 2 illustrates a sectional view of an aperture of a vehicle connector, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Vehicle Covering Assembly 100

Vertical Poles 110

Horizontal Poles 120

Vehicle Connectors 130

Cushion Portion 131

Corner Pole Connectors 140

Pole Connector Cushion Portion 141

Divider Connectors 150

Divider Cushion Portion 151

Covers 160

Cover Fasteners 170

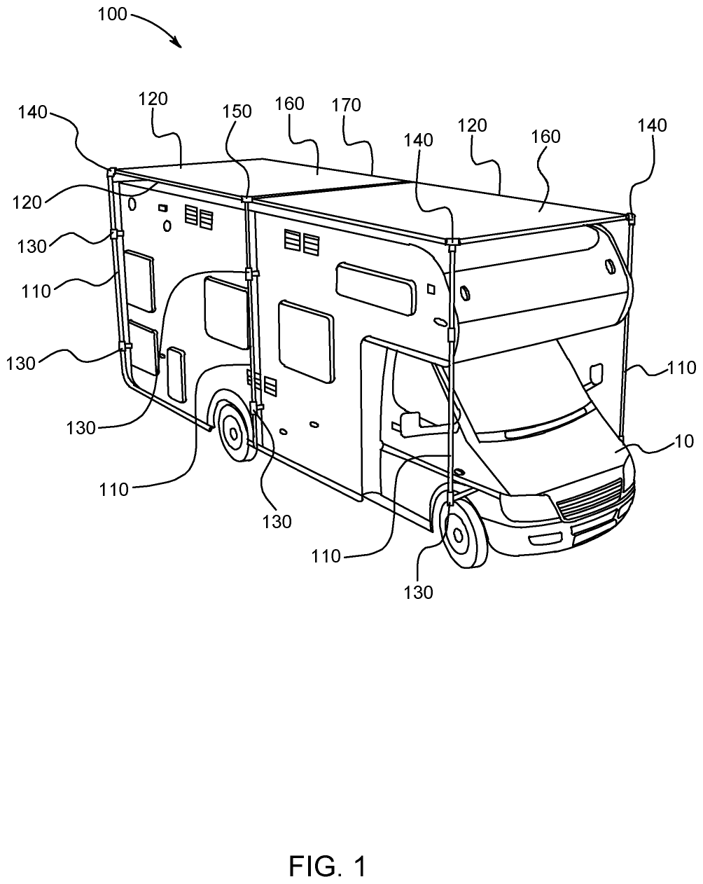

FIG. 1 illustrates an isometric view of a vehicle covering assembly 100, according to an exemplary embodiment of the present general inventive concept.

The vehicle covering assembly 100 may be constructed from at least one of metal, plastic, wood, cloth, vinyl, and rubber, etc., but is not limited thereto.

The vehicle covering assembly 100 may include a plurality of vertical poles 110, a plurality of horizontal poles 120, a plurality of vehicle connectors 130, a plurality of corner pole connectors 140, a plurality of divider connectors 150, a plurality of covers 160, and a plurality of cover fasteners 170, but is not limited thereto.

Each of the plurality of vertical poles 110 may be a single pole having a predetermined length at least corresponding to a height of a vehicle 10, such as a recreational vehicle (RV) and/or a camper. Moreover, a length of each of the plurality of vertical poles 110 may exceed the height of the vehicle 10.

Referring to FIG. 1, the plurality of vertical poles 110 may be disposed vertically on a first side of the vehicle 10 and/or a second side of the vehicle 10 opposite with respect to the first side of the vehicle 10. In other words, the plurality of vertical poles 110 may be perpendicularly disposed away from a ground surface with respect to a direction. However, the plurality of vertical poles 110 may not contact and/or connect to the ground surface, only the vehicle 10. Alternatively, each of the plurality of vertical poles 110 may comprise segments connected at ends to form a pole disposed on a side of the vehicle 10.

Each of the plurality of horizontal poles 120 may be a single pole having a predetermined length at least corresponding to a length and/or a width of the vehicle 10. Moreover, a length of each of the plurality of horizontal poles 120 may exceed the length and/or the width of the vehicle 10.

Alternatively, referring to FIG. 1, each of the plurality of horizontal poles 120 may comprise segments connected at ends to form a single pole connected to and perpendicularly disposed away from a first end and/or a second end of at least one of the plurality of vertical poles 110, such that the plurality of horizontal poles 120 are horizontal and suspended above a roof of the vehicle 10.

Accordingly, the plurality of horizontal poles 120 may form a rectangular shape with respect to a first plane.

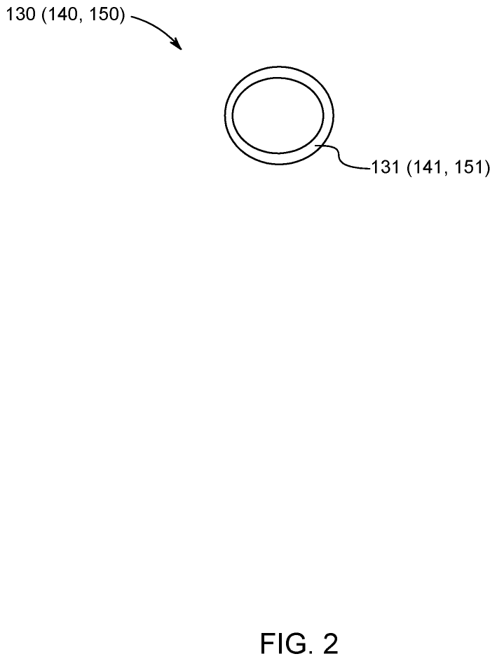

FIG. 2 illustrates a sectional view of an aperture of a vehicle connector 130, according to an exemplary embodiment of the present general inventive concept.

Each of the plurality of vehicle connectors 130 may include a cushion portion 131, but is not limited thereto.

Also, each of the plurality of vehicle connectors 130 may further include a clip and a pole connector, but is not limited thereto.

Each of the plurality of vehicle connectors 130 may be removably connected (e.g., clipped, adhesive, magnet) to at least a portion of the first side of the vehicle 10 and/or the second side of the vehicle 10. Moreover, each of the plurality of vehicle connectors 130 may receive at least one of the plurality of vertical poles 110 therethrough. As such, the plurality of vehicle connectors 130 may connect the plurality of vertical poles 110 to the first side and/or the second side of the vehicle 10, such that each of the plurality of vehicle connectors 130 may suspend at least one of the plurality of vertical poles 110 therefrom.

Furthermore, the plurality of vehicle connectors 130 may protrude a distance away from the vehicle 10, such that only a portion of the plurality of vehicle connectors 130 connects to the vehicle 10. In other words, an entire length of each of the plurality of vehicle connectors 130 may be unattached to the vehicle 10, while only a portion thereof is attached.

The cushion portion 131 may be constructed of a foam, a gel, a sponge, and/or any combination thereof, but is not limited thereto.

Additionally, the cushion portion 131 may be circumferentially disposed within at least a portion of an aperture on an interior surface of each of the plurality of vehicle connectors 130. In other words, the cushion portion 131 may be disposed on a perimeter of the aperture within each of the plurality of vehicle connectors 130. As such, the cushion portion 131 may at least partially deform (i.e. expand, bend, stretch) in response to contact from at least one of the plurality of vertical poles 110. Therefore, each of the plurality of vertical poles 110 inserted into the aperture of each of the plurality of vehicle connectors 130 and through the cushion portion 131 may snugly fit therein. In other words, the cushion portion 131 may snugly receive at least one of the plurality of vertical poles 110 therein. Also, the cushion portion 131 may absorb movement of the plurality of vertical poles 110 based on an impact to each of the plurality of vertical poles 110 within the cushion portion 131. Subsequently, the cushion portion 131 may return to its original shape in absence of at least one of the plurality of vertical poles 110 therein.

Referring again to FIG. 1, it is important to note that each of the plurality of vehicle connectors 130 may have two apertures disposed at opposite ends thereof.

Each of the plurality of corner pole connectors 140 may include a pole connector cushion portion 141, but is not limited thereto.

Each of the plurality of corner pole connectors 140 may be removably connected to at least a portion of the first end and/or the second end of at least one of the plurality of vertical poles 110. Moreover, each of the plurality of corner pole connectors 140 may receive the first end and/or the second end of at least one of the plurality of vertical poles 110 therein and/or a first end and/or a second end of at least one of the plurality of horizontal poles 120 therein. As such, each of the plurality of corner pole connectors 140 may removably connect at least one of the plurality of vertical poles 110 to at least one of the plurality of horizontal poles 120, such that each of the plurality of corner pole connectors 140 may suspend at least one of the plurality of horizontal poles 120 on at least one of the plurality of vertical poles 110.

The pole connector cushion portion 141 may be constructed of a foam, a gel, a sponge, and/or any combination thereof, but is not limited thereto.

Additionally, the pole connector cushion portion 141 may be circumferentially disposed within at least a portion of an aperture on an interior surface of each of the plurality of corner pole connectors 140. In other words, the pole connector cushion portion 141 may be disposed on a perimeter of the aperture within each of the plurality of corner pole connectors 140. As such, the pole connector cushion portion 141 may at least partially deform (i.e. expand, bend, stretch) in response to contact from at least one of the plurality of vertical poles 110 and/or at least one of the plurality of horizontal poles 120. Therefore, each of the plurality of vertical poles 110 and/or each of the plurality of horizontal poles 120 inserted into the aperture of each of the plurality of corner pole connectors 140 and through the pole connector cushion portion 141 may snugly fit therein. Also, the pole connector cushion portion 141 may absorb movement of the plurality of vertical poles 110 and/or the plurality of horizontal poles 120 based on an impact to each of the plurality of vertical poles 110 and/or each of the plurality of horizontal poles 120 within the pole connector cushion portion 141. Subsequently, the pole connector cushion portion 141 may return to its original shape in absence of at least one of the plurality of vertical poles 110 and/or at least one of the plurality of horizontal poles 120 therein.

Referring again to FIG. 1, it is important to note that each of the plurality of corner pole connectors 140 may have two apertures perpendicularly disposed away from each other, and a third aperture perpendicularly disposed away from the first two apertures with respect to a direction different than the first two apertures.

Each of the plurality of divider connectors 150 may include a divider cushion portion 151, but is not limited thereto.

Each of the plurality of divider connectors 150 may be removably connected to at least a portion of the first end and/or the second end of at least one of the plurality of vertical poles 110 and disposed between two of the plurality of corner pole connectors 140 on the first side and/or the second side of the vehicle 10. Moreover, each of the plurality of divider connectors 150 may receive the first end and/or the second end of at least one of the plurality of vertical poles 110 therein and/or the first end and/or the second end at least one of the plurality of horizontal poles 120 therein. As such, each of the plurality of divider connectors 150 may removably connect at least one of the plurality of vertical poles 110 to at least one of the plurality of horizontal poles 120, such that each of the plurality of divider connectors 150 may suspend at least one of the plurality of horizontal poles 120 on at least one of the plurality of vertical poles 110.

Furthermore, each of the plurality of divider connectors 150 may be disposed between two of the plurality of corner pole connectors 140.

The divider cushion portion 151 may be constructed of a foam, a gel, a sponge, and/or any combination thereof, but is not limited thereto.

Additionally, the divider cushion portion 151 may be circumferentially disposed within at least a portion of an aperture on an interior surface of each of the plurality of divider connectors 150. In other words, the divider cushion portion 151 may be disposed on a perimeter of the aperture within each of the plurality of divider connectors 150. As such, the divider cushion portion 151 may at least partially deform (i.e. expand, bend, stretch) in response to contact from at least one of the plurality of vertical poles 110 and/or at least one of the plurality of horizontal poles 120. Therefore, each of the plurality of vertical poles 110 and/or each of the plurality of horizontal poles 120 inserted into the aperture of each of the plurality of divider connectors 150 and through the divider cushion portion 151 may snugly fit therein. Also, the divider cushion portion 151 may absorb movement of the plurality of vertical poles 110 and/or the plurality of horizontal poles 120 based on an impact to each of the plurality of vertical poles 110 and/or each of the plurality of horizontal poles 120 within the divider cushion portion 151. Subsequently, the divider cushion portion 151 may return to its original shape in absence of at least one of the plurality of vertical poles 110 and/or at least one of the plurality of horizontal poles 120 therein.

Referring again to FIG. 1, it is important to note that each of the plurality of divider connectors 150 may have two apertures disposed at opposite ends thereof, a third aperture perpendicularly disposed away from the first two apertures with respect to a first direction different than the first two apertures, and a fourth aperture perpendicularly disposed away from the first three aperture with respect to a second direction different from the first direction.

Each of the plurality of covers 160 may be constructed canvas, polyester, and/or polyethylene. Moreover, each of the plurality of covers 160 may be tarpaulin that is waterproof and fireproof. Also, the plurality of covers 160 may prevent an ultraviolet (UV) light from passing therethrough. In other words, the plurality of UV covers 160 blocks UV light.

Referring again to FIG. 1, each of the plurality of covers 160 may be removably connected and/or disposed between each of the plurality of horizontal poles 120. The plurality of covers 160 is illustrated to have two covers 160 separated by at least one of the plurality of horizontal poles 120 connected to two of the plurality of divider connectors 150. However, the plurality of covers 160 may be a single cover 160 that takes up the same area as the plurality of covers 160. In other words, the plurality of divider connectors 150 and/or at least one of the plurality of horizontal poles 120 connected to the plurality of divider connectors 150 would not be used when only one cover 160 is used.

The plurality of covers 160 may suspend from each of the plurality of horizontal poles 120, such that the plurality of covers 160 covers at least a portion of the roof and/or a body of the vehicle 10. Accordingly, each of the plurality of covers 160 may prevent damage to the vehicle 10 by preventing objects such as leaves, branches, nuts, tree sap, rain, and/or any other object from contacting the roof and/or the body of the vehicle 10.

Each of the plurality of cover fasteners 170 may include a string, a rope, a wire, a twine, an adhesive, and a magnet, but is not limited thereto.

Each of the plurality of cover fasteners 170 may be disposed on at least a portion of each edge of the plurality of covers 160. The plurality of cover fasteners 170 may be removably connected to at least one of the plurality of horizontal poles 120 to connect and/or suspend the plurality of covers 160 from the plurality of horizontal poles 120.

Therefore, the vehicle covering assembly 100 may adapt to any size of the vehicle 10 and is portable, such that it can be detached from the vehicle 10 and collapsed for storage. Also, the vehicle covering assembly 100 may prevent damage to the vehicle 10 from outdoor elements.

The present general inventive concept may include a vehicle covering assembly 100, including a plurality of vertical poles 110 vertically disposed on a first side and a second side of a vehicle 10 opposite with respect to the first side, a plurality of horizontal poles 120 perpendicularly disposed away from an end of at least one of the plurality of vertical poles 110 to suspend above a roof of the vehicle 10, and a plurality of vehicle connectors 130 removably connected to at least a portion of the first side of the vehicle 10 and the second side of the vehicle 10, such that each of the plurality of vehicle connectors 130 receive at least one of the plurality of vertical poles 110 therethrough.

The plurality of vertical poles 110 may be suspended from the plurality of vehicle connectors 130 above a ground surface while the plurality of vehicle connectors 130 are connected to the vehicle 10.

Each of the plurality of vehicle connectors 130 may include a cushion portion 131 circumferentially disposed within at least a portion of an interior surface of each of the plurality of vehicle connectors 130 to snugly receive at least one of the plurality of vertical poles 110 therein.

The cushion portion 131 may at least partially deform in response to contact from at least one of the plurality of vertical poles 110.

The vehicle covering assembly 100 may further include a plurality of corner pole connectors 140 removably connected to at least a portion of the end of at least one of the plurality of vertical poles 110 to removably connect at least one of the plurality of vertical poles 110 to at least one of the plurality of horizontal poles 120, such that each of the plurality of corner pole connectors 140 suspends at least one of the plurality of horizontal poles 120 on at least one of the plurality of vertical poles 110.

The vehicle covering assembly 100 may further include a plurality of divider connectors 150 removably connected to at least a portion of the end of at least one of the plurality of vertical poles 110 and disposed between two of the plurality of corner pole connectors 140 on at least one side of the vehicle 10 to removably connect at least one of the plurality of vertical poles 110 to at least one of the plurality of horizontal poles 120, such that each of the plurality of divider connectors 150 suspends at least one of the plurality of horizontal poles 120 on at least one of the plurality of vertical poles 110.

The vehicle covering assembly 100 may further include a plurality of covers 160 removably connected and suspended between each of the plurality of horizontal poles 120 to cover at least a portion of the roof and a body of the vehicle 10.

The plurality of covers 160 may prevent ultraviolet light from passing therethrough.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A vehicle covering assembly, comprising:
a plurality of vertical poles vertically disposed on a first side and a second side of a vehicle opposite with respect to the first side;
a plurality of horizontal poles perpendicularly disposed away from an end of at least one of the plurality of vertical poles to suspend above a roof of the vehicle; and
a plurality of vehicle connectors removably connected to at least a portion of the first side of the vehicle and the second side of the vehicle, such that each of the plurality of vehicle connectors receive at least one of the plurality of vertical poles therethrough.

2. The vehicle covering assembly of claim 1, wherein the plurality of vertical poles are suspended from the plurality of vehicle connectors above a ground surface while the plurality of vehicle connectors are connected to the vehicle.

3. The vehicle covering assembly of claim 1, wherein each of the plurality of vehicle connectors comprises:
a cushion portion circumferentially disposed within at least a portion of an interior surface of each of the plurality of vehicle connectors to snugly receive at least one of the plurality of vertical poles therein.

4. The vehicle covering assembly of claim 3, wherein the cushion portion at least partially deforms in response to contact from at least one of the plurality of vertical poles.

5. The vehicle covering assembly of claim 1, further comprising:
a plurality of corner pole connectors removably connected to at least a portion of the end of at least one of the plurality of vertical poles to removably connect at least one of the plurality of vertical poles to at least one of the plurality of horizontal poles, such that each of the plurality of corner pole connectors suspends at least one of the plurality of horizontal poles on at least one of the plurality of vertical poles.

6. The vehicle covering assembly of claim 5, further comprising:
a plurality of divider connectors removably connected to at least a portion of the end of at least one of the plurality of vertical poles and disposed between two of the plurality of corner pole connectors on at least one side of the vehicle to removably connect at least one of the plurality of vertical poles to at least one of the plurality of horizontal poles, such that each of the plurality of divider connectors suspends at least one of the plurality of horizontal poles on at least one of the plurality of vertical poles.

7. The vehicle covering assembly of claim 1, further comprising:
a plurality of covers removably connected and suspended between each of the plurality of horizontal poles to cover at least a portion of the roof and a body of the vehicle.

8. The vehicle covering assembly of claim 8, wherein the plurality of covers prevents ultraviolet light from passing therethrough.
